(19) United States
(12) Patent Application Publication
(10) Pub. No.: US 2022/0297044 A1
(43) Pub. Date: Sep. 22, 2022

(54) MULTI-COMPARTMENT NEGATIVE AIR FILTRATION

(71) Applicant: Carrier Corporation, Palm Beach Gardens, FL (US)

(72) Inventor: Munish Kumar, Gurugram (IN)

(21) Appl. No.: 17/249,836

(22) Filed: Mar. 16, 2021

(51) Int. Cl. B01D 46/00

(52) U.S. Cl. CPC B01D 46/0049; B01D 46/0086; B01D 46/0023; B01D 46/002; B01D 2273/30; B01D 2271/02; B01D 2265/025

(57) ABSTRACT

A multi-compartment negative air filtration system and a method of operating a multi-compartment negative air filtration system are provided. The multi-compartment negative air filtration system includes a housing including a first compartment and a second compartment. The first compartment and the second compartment separated by at least one panel member. Each of the first compartment and the second compartment including an inlet, an outlet, a pre-filter disposed downstream of the inlet, a HEPA filter disposed downstream of the pre-filter, an a fan assembly disposed downstream of the HEPA filter, the fan assembly in airflow communication with the pre-filter and the HEPA filter, the fan assembly generating a negative pressure across the pre-filter and the HEPA filter.

### BACKGROUND

Negative air machines are used to remove contaminants from the air of an enclosed space. For example, negative air machines may be used to remove asbestos, mold, and/or microbes from the air. Once the negative air machine filters the contaminants from the air, depending on the configuration, the air may be either recycled within the space, or exhausted outside the space.

Negative air machines have been found to be particularly useful in hospital settings, where negative air machines are placed in particular rooms. Specifically, negative air machines have been used in various types of isolation rooms (e.g., airborne infection isolation (AII) rooms, protective isolation/environment (PE) rooms, convertible isolation rooms, and combination AII/PE rooms). By placing the negative air machines in these rooms, the spread of infectious diseases may be prevented, or at least mitigated.

To remove the microbes from the air, traditional negative air machines include a fan, at least one pre-filter, and a HEPA filter. The fan is used to create a negative pressure and draw air into the negative air machine (e.g., through the inlet and out of the outlet). The pre-filter is used to remove larger particles and debris from the air (e.g., large dust particles, hair, etc.). The HEPA filter is used to remove smaller particles from the air (e.g., the microbes). Commonly, the fan is disposed at the inlet of the negative air machine, with one or more of the filters (e.g., the pre-filter and/or the HEPA filter) disposed downstream of the fan. This generates a positive pressure across the filter(s) downstream of the fan. This positive pressure may cause increased stress on the filter(s) and/or on any seal around the filter(s), which may result in a leak of contaminants (e.g., either through a hole in a filter or through an opening in a seal around a filter). If contaminants are able to leak through the negative air machine then the negative air machine may not reliably prevent the spread of infectious diseases.

Traditionally, negative air machines include only compartment with only one inlet and only one outlet, which makes the negative air machine only capable of exhausting the treated air either in a single direction (i.e., either within the space or outside the space). This results in reduced flexibility for providing optimal treatment for certain types of spaces (e.g., hospital rooms, classrooms, etc.).

Accordingly, there remains a need for a multi-compartment negative air machine and method of operating such negative air machine, that is effectively removes contaminants from the air, while also providing increased flexibility.

### BRIEF DESCRIPTION

According to one embodiment, a multi-compartment negative air filtration system is provided. The multi-compartment negative air filtration system includes a housing including a first compartment and a second compartment, the first compartment and the second compartment separated by at least one panel member. Each of the first compartment and the second compartment include an inlet, an outlet, a pre-filter disposed downstream of the inlet, a HEPA filter disposed downstream of the pre-filter, and a fan assembly disposed downstream of the HEPA filter. The fan assembly is in airflow communication with the pre-filter and the HEPA filter. The fan assembly generates a negative pressure across the pre-filter and the HEPA filter.

In accordance with additional or alternative embodiments, the fan assembly of the first compartment and the fan assembly of the second compartment share a constant torque motor with an operating torque.

In accordance with additional or alternative embodiments, the constant torque motor is operably connected to a selection device, the selection device configured to adjust the operating torque.

In accordance with additional or alternative embodiments, the operating torque correlates to an approximately constant RPM, wherein the approximately constant RPM is between 800 and 1500 RPM.

In accordance with additional or alternative embodiments, the fan assembly of the first compartment and the fan assembly of the second compartment each independently include a forward curved wheel blower.

In accordance with additional or alternative embodiments, the housing further includes an interior surface, wherein an insulation is disposed on at least a portion of the interior surface.

In accordance with additional or alternative embodiments, the insulation includes an exterior foil surface and a fiberglass body.

In accordance with additional or alternative embodiments, each respective outlet includes a supply duct transition, each supply duct transition including an outlet flange and an outlet plate, wherein the outlet plate includes a plurality of apertures disposed therein.

In accordance with additional or alternative embodiments, the multi-compartment negative air filtration system further includes at least one pressure switch, the pressure switch operably connected to an indicator, the indicator disposed on the housing.

In accordance with additional or alternative embodiments, the pressure switch includes a tube, the tube including a first end and a second end, the first end disposed outside the housing and the second end disposed between the fan assembly and the HEPA filter.

In accordance with additional or alternative embodiments, the indicator is configured to signal when at least one of the pre-filter and the HEPA filter are in need of replacement.

T In accordance with additional or alternative embodiments, the HEPA filter includes an exterior perimeter, a sealing assembly disposed about the exterior perimeter, the sealing assembly configured prevent a bypass around the HEPA filter.

In accordance with additional or alternative embodiments, the sealing assembly includes at least one gasket and at least one planar member.

In accordance with additional or alternative embodiments, the multi-compartment negative air filtration system further includes a mounting rail disposed within the housing, the mounting rail disposed adjacent the sealing assembly.

In accordance with additional or alternative embodiments, the inlet is disposed on a lower surface of the housing and the outlet is disposed on an upper surface of the housing, the inlet and the outlet being vertically oriented.

In accordance with additional or alternative embodiments, the multi-compartment negative air filtration system further includes a plurality of wheels disposed on the lower surface of the housing.

In accordance with additional or alternative embodiments, wherein the lower surface includes a surface area less 8 sq. ft.

According to another aspect of the disclosure, a method for operating a multi-compartment negative air filtration system within a room is provided. The multi-compartment negative air filtration system includes a housing with a first compartment and a second compartment separated by at least one panel member, each of the first compartment and the second compartment including a pre-filter, a HEPA filter disposed downstream of the pre-filter, and a fan assembly disposed downstream of the HEPA filter. The method includes a step for operating the first compartment in at least one of an air scrubber mode and a negative air mode, the air scrubber mode being defined by a first exhausted air being discharged within the room, the negative air mode being defined by the first exhausted air being discharged outside the room. The method includes a step for operating the second compartment in at least one of an air scrubber mode and a negative air mode, the air scrubber mode being defined by a second exhausted air being discharged within the room, the negative air mode being defined by the second exhausted air being discharged outside the room.

In accordance with additional or alternative embodiments, both the first compartment and the second compartment are operated identically.

In accordance with additional or alternative embodiments, one of the first compartment and the second compartment are operated in the air scrubber mode and one of the first compartment and the second compartment are operating in negative air mode.

### BRIEF DESCRIPTION OF THE DRAWINGS

The subject matter, which is regarded as the disclosure, is particularly pointed out and distinctly claimed in the claims at the conclusion of the specification. The following descriptions of the drawings should not be considered limiting in any way. With reference to the accompanying drawings, like elements are numbered alike:

FIG. 1 is a perspective view of a multi-compartment negative air filtration system, in accordance with one aspect of the disclosure.

FIG. 2 is a perspective view of the pre-filter, as shown in FIG. 1, with insulation disposed on the interior surface of the housing, in accordance with one aspect of the disclosure.

FIG. 3 is a perspective view of a supply duct transition, in accordance with one aspect of the disclosure.

FIG. 4 is a perspective view of a pressure switch, in accordance with one aspect of the disclosure.

FIG. 5 is a perspective view of an indicator and a dial disposed on the housing, in accordance with one aspect of the disclosure.

FIG. 6 is a perspective view of two fan assemblies, sharing a constant torque motor, in accordance with one aspect of the disclosure.

FIG. 7 is a perspective view of a HEPA filter, depicting the exterior perimeter of the HEPA filter, in accordance with one aspect of the disclosure.

FIG. 8 is a perspective view of a sealing assembly disposed about the exterior perimeter of the HEPA filter shown in FIG. 7, in accordance with one aspect of the disclosure.

FIG. 9 is an illustration of the multi-compartment negative air filtration system, shown in FIG. 1, disposed within a room, with the first compartment operating in an air scrubber mode and the second compartment operating in a negative air mode, in accordance with one aspect of the disclosure.

FIG. 10 is a flow diagram illustrating a method of operating a multi-compartment negative air filtration system within a room, in accordance with one aspect of the disclosure.

### DETAILED DESCRIPTION

A multi-compartment negative air filtration system and a method of operating the multi-compartment negative air filtration system within a room are provided. The multi-compartment negative air filtration system includes a housing defining a first compartment and second compartment separated by at least one panel member. Each of the first compartment and the second compartment of the multi-compartment negative air filtration system include, an inlet and an outlet, a pre-filter, a HEPA filter, and a fan assembly. The multi-compartment negative air filtration system, by disposing the fan assemblies downstream of the HEPA filters and the pre-filters, generates a negative pressure across the pre-filters and the HEPA filters. By generating a negative pressure across the filters (e.g., instead of a positive pressure), the multi-compartment negative air filtration system may more reliably prevent the spread of infectious diseases (e.g., compared to existing negative air filtration systems) by avoiding the generation of unneeded stress on the filters and the seal around the filters. In addition, the multi-compartment negative air filtration system provided herein, by including multiple compartments, each with their own inlet and outlet, may have increased flexibility for providing optimal treatment. For example, instead of only being able to exhaust the treated in a single direction (i.e., either within the room or outside the room), the multi-compartment negative air filtration system described herein may be able to exhaust the treated air in multiple directions, resulting in increased control of airflow within the room. Although described herein to be particularly useful in a hospital setting, it should be appreciated that the negative air filtration system may be used within any environment that is in need of contaminant filtration (e.g., classrooms, offices, home remediation, etc.).

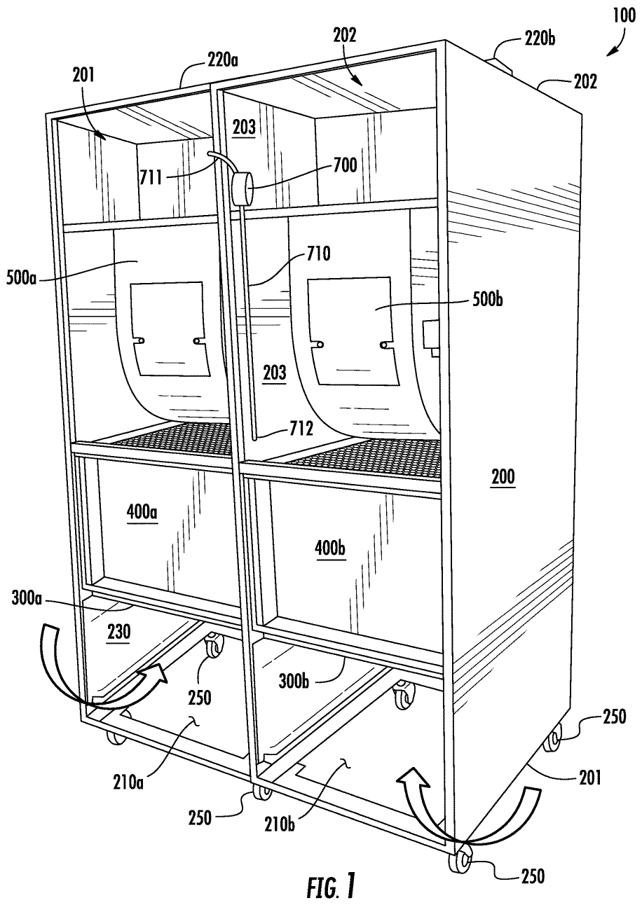

With reference now to the Figures, an exemplary multi-compartment negative air filtration system 100 is shown in FIG. 1. The multi-compartment negative air filtration system 100 includes a housing 200, which defines a first compartment 201 and a second compartment 202. The first compartment 201 and the second compartment 202 are separated by at least one panel member 203 (e.g., which may be sheet metal, etc.). Each of the first compartment 201 and the second compartment 202 include an inlet 210, an outlet 220, a pre-filter 300, a HEPA filter 400, and a fan assembly 500. It should be appreciated that like components within each compartment 201, 202 may be labeled similarly, but may be differentiated using an “(a)” or “(b)” addition. For example, as shown in FIG. 1, the HEPA filter 400 in the first compartment 201 includes “(a)”, whereas the HEPA filter 400 in the second compartment 202 includes “(b)”. It will be appreciated that the components within each compartment 201, 202 may be approximately identical to one another in certain instances.

As shown in FIG. 1, the pre-filters 300 are disposed within the housing 200, downstream of the inlets 210. The HEPA filters 400 are disposed within the housing 200, downstream of the pre-filters 300. The fan assemblies 500 are disposed within the housing 200, downstream of the HEPA filters 400. The fan assemblies 500 are in airflow communication with the pre-filters 300 and the HEPA filters 400. Being in airflow communication may be interpreted to mean that the airflow that is drawn into the multi-compartment negative air filtration system 100 (e.g., by the fan assemblies 500) is passed through the fan assemblies 500, the pre-filters 300, and the HEPA filters 400. The fan assemblies 500 generate a negative pressure across the pre-filters 300 and the HEPA filters 400 (e.g., instead of a positive pressure).

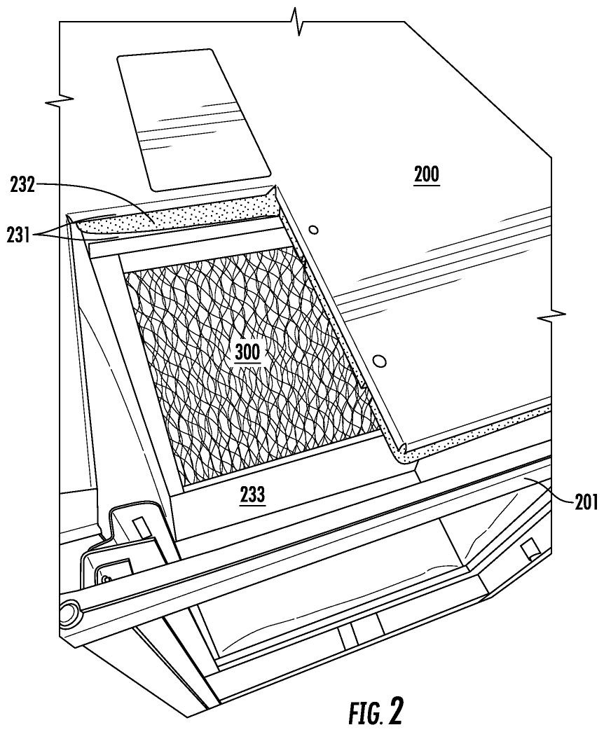

The housing 200 includes an interior surface 230, which may include insulation 231. For example, the housing 200 may be made of one or more pieces of sheet metal joined together (e.g., using any known fastening means) at the corners of the housing 200. The interior surface 230 of the housing 200 may be viewed as the inward facing surface of the pieces of sheet metal. In certain instances, the insulation 231 may line the entire interior surface 230 of the housing 200 to minimize noise outside the housing 200. It should be appreciated that, in certain instances, the insulation 231 lines only a portion of the interior surface 230 of the housing 200 (e.g., may only line the interior surface 230 near the fan assemblies 500, etc.). As shown in FIG. 2, the insulation 231 may include an exterior foil surface 233 and a fiberglass body 232.

The pre-filters 300 may be disposed directly adjacent to the HEPA filters 400. A perspective view of a pre-filter 300 installed within the multi-compartment negative air filtration system 100 is shown in FIG. 2. The pre-filters 300 may be easily removable and replaceable (e.g., if/when the pre-filter 300 becomes clogged). The pre-filters 300 may be used to remove larger particles (e.g., hair, dust, etc.) from the air entering the multi-compartment negative air filtration system 100 to avoid the larger particles from clogging the HEPA filter 400. The HEPA filters 400 may be used to remove fine contaminants (e.g., microbes, etc.) from the air before the air is either recycled within the space (e.g., back into the room, when operating in an air scrubber mode), or exhausted outside the space (e.g., outside of the room and/or building, when operating in a negative air mode).

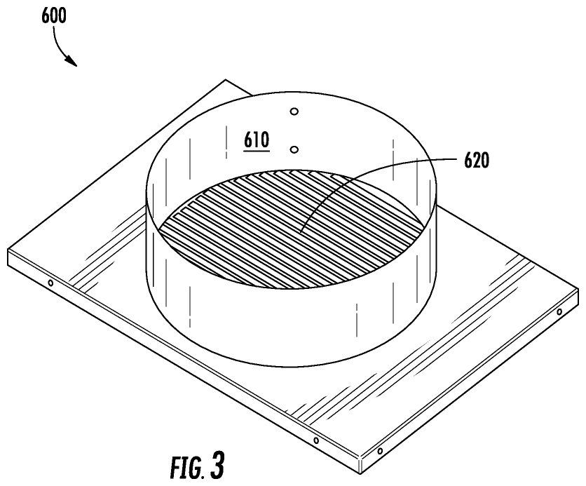

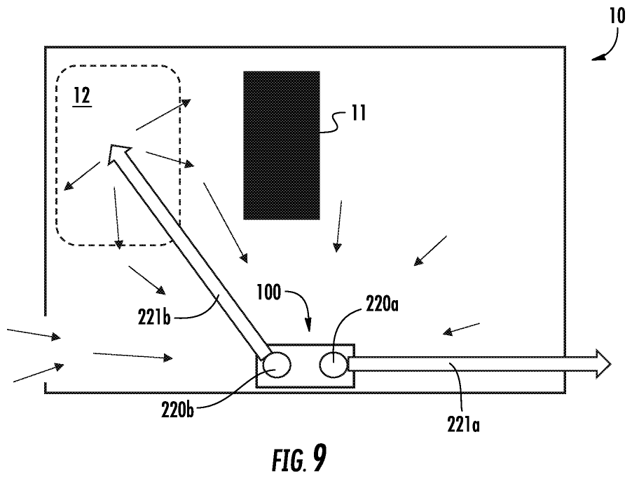

When exiting the multi-compartment negative air filtration system 100, the air may be passed through a duct (not shown). For ease of installation (e.g., to make it easy to connect with the duct), the multi-compartment negative air filtration system 100 may include a supply duct transition 600 (as shown in FIGS. 3). The supply duct transition 600 may be disposed on an upper surface 202 of the housing 200. The supply duct transition 600 may include an outlet flange 610 and an outlet plate 620 containing a plurality of apertures. The outlet flange 610 may extend circumferentially around the outlet plate 620. The outlet flange 610 may extend substantially perpendicular from the upper surface 202 of the housing 200. Substantially perpendicular may mean that the outlet flange 610 and the upper surface 202 of the housing 200 may form an angle of approximately 90° (e.g., +/−5°). The outlet flange 610 may be sized to allow a duct to be configured over the outlet flange 610 (e.g., to allow the duct to be clamped to the outside of the outlet flange 610). The outlet plate 620 may be configured in any fashion capable of allowing air to flow out of the multi-compartment negative air filtration system 100 and through the duct 221 (shown in FIG. 9).

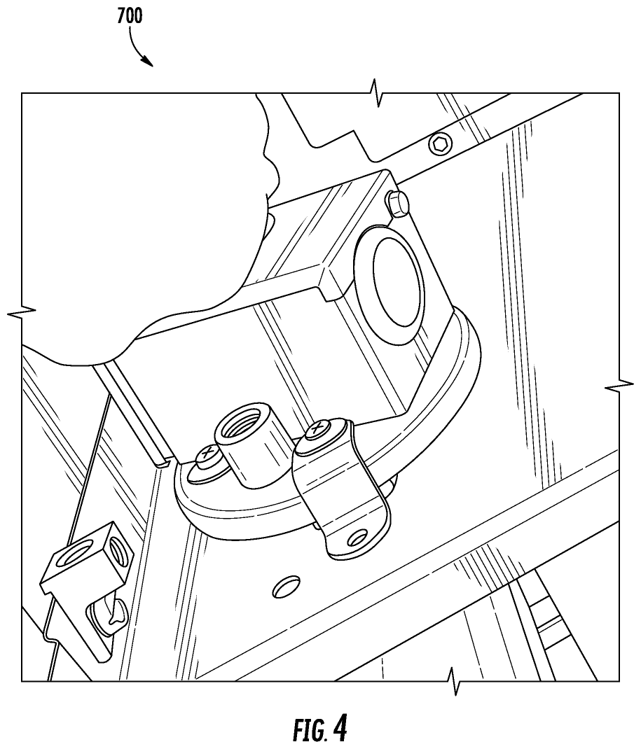

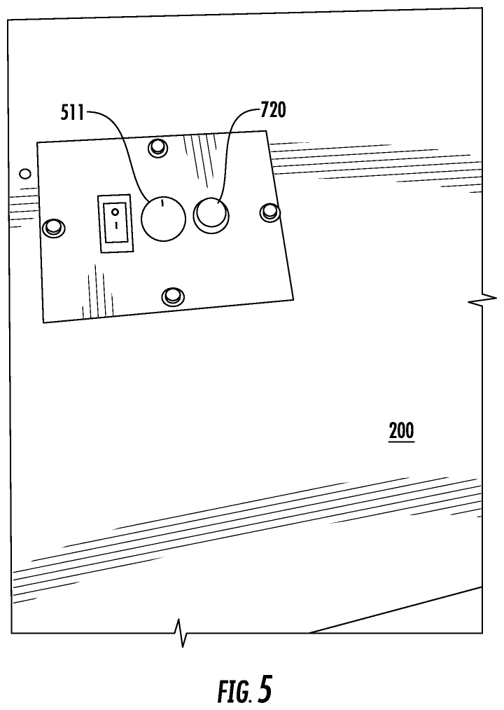

To function efficiently and effectively remove contaminants from the air, the filters (e.g., the pre-filters 300 and the HEPA filters 400) of the multi-compartment negative air filtration system 100 need to remain unclogged. To monitor the status of the filters the multi-compartment negative air filtration system 100 may include a pressure switch 700 (as shown in FIGS. 1 and 4). The pressure switch 700 may be operably connected to an indicator 720 (e.g., through one or more wired or wireless connections). The indicator 720 may include any device capable of signaling (e.g., capable of generating a sound and/or light). In certain instances, the indicator 720 is a light (e.g., an LED) disposed on the housing 200 (as shown in FIG. 5). The indicator 720 may be used by the multi-compartment negative air filtration system 100 to signal (e.g., by flashing) when at least one of the pre-filters 300 and the HEPA filters 400 are in need of replacement.

The pressure switch 700 may trigger the indicator 720 using a diaphragm (not shown). For example, the pressure switch 700 may have a flexible diaphragm connected to a tube 710 (shown in FIG. 1). The diaphragm may move relative to a change in pressure (e.g., triggering the indicator 720). The tube 710 may include a first end 711 disposed outside the housing 200 (e.g., open to atmosphere) and a second end 712 disposed inside the housing 200 (e.g., between the fan assembly 500 and the HEPA filter 400). Thus, the pressure switch 700 may monitor a pressure change between at least one of fan assemblies 500 and at least one of the HEPA filters 400 and trigger the indicator 720 when the pressure drops to a point that is indicative of a filter (e.g., a pre-filter 300 or a HEPA filter 400) being clogged to the point that it is in need of replacement. It should be appreciated that the configuration of a pre-filters 300 upstream of the HEPA filters 400 may mitigate the HEPA filter 400 from becoming clogged with larger particles (e.g., dust, hair, etc.). As mentioned above, clogged filters may affect the efficiency of the multi-compartment negative air filtration system 100. For example, a clogged filter may cause the fan assemblies 500 to consume more power.

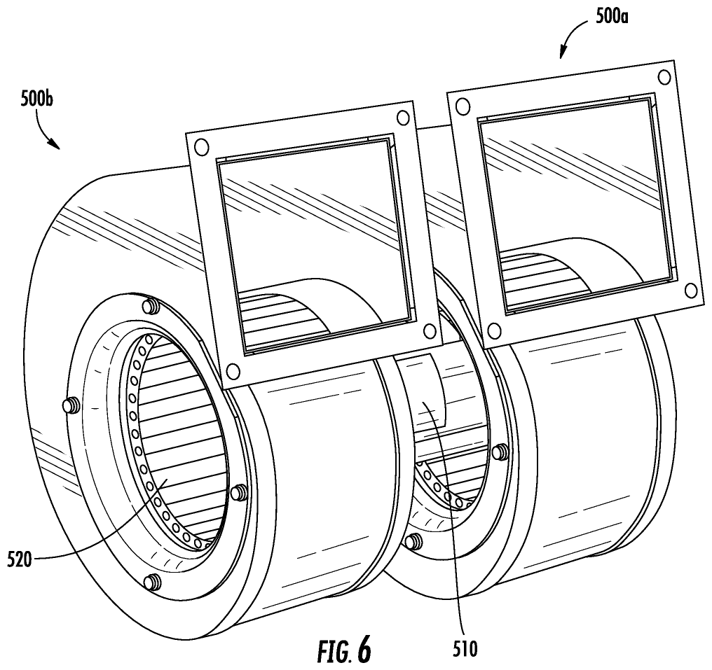

A perspective view of the exemplary fan assemblies 500 is shown in FIG. 6. As shown, the fan assembly 500(a) of the first compartment 201 and the fan assembly 500(b) of the second compartment 202 may share a constant torque motor 510. This shared motor 510 may drive each forward curved wheel blowers 520 (which, as shown, may be independently positioned within a respective compartment 201, 202). It should be appreciated that this shared motor 510 may result in reduced power consumption (when compared to if two independent motors 510 were used for each fan assembly 500). In addition, by having a shared motor 510, there is potential to operate the motor at lower speed while still achieve the desired airflow. This may result in less noise being generated by the motor 510, which, depending on the environment in which the system 100 is used, may be beneficial. It is envisioned that multi-compartment negative air filtration system 100 may be used in classrooms, offices, hospitals, etc., each of which may have a desire for reduced ambient noise. It is envisioned, although not shown, that each fan assembly 500 may include independent motors 510 (each positioned independently from one another within a respective compartment 201, 202).

In certain instances, the fan assemblies 500 may not use a constant CFM motor (e.g., which may incorporate one or more microprocessor). The constant torque motor 510 may be operably connected (e.g., through one or more wired or wireless connections) to a selection device 511 (e.g. a dial shown in FIG. 5). The selection device 511 may be configured to adjust the operating torque (e.g., which may correlate to an approximately constant RPM) between various approximately constant torques. An approximately constant torque may mean that the torque does not vary substantially during operation (e.g., +/−100 Nm from the set torque). For example, the selection device 511 may change the operating torque of the constant torque motor(s) 510 between a number (e.g., five or more) of different present constant torques, which may not vary substantially during operation (e.g., without adjusting the dial 511). In certain instances, the approximately constant RPM for which the torque correlates to is between 800 and 1500 RPM. The selection device 511 may make it possible to adjust the output (e.g., the CFM) of the fan assemblies 500 based on the size of the particular space that the multi-compartment negative air filtration system 100 is being used in. For example, the selection device 511 may increase the torque for a larger room and decrease the torque for a smaller room. Regardless of the size of the room, the fan assemblies 500 may be used to pull air through the HEPA filters 400 to remove contaminants (e.g., microbes) from the air.

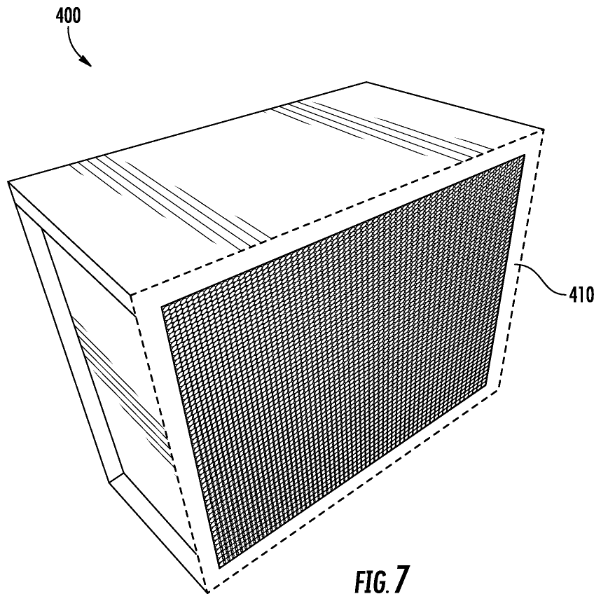

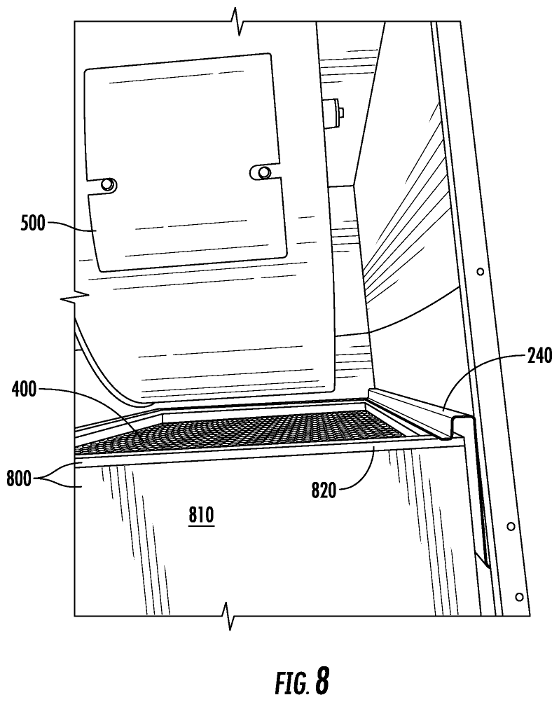

The multi-compartment negative air filtration system 100 may prevent air from bypassing the HEPA filters 400. An exemplary embodiment of a HEPA filter 400 is shown in FIG. 7. As shown in FIG. 7, the HEPA filters 400 may include an exterior perimeter 410. The multi-compartment negative air filtration system 100 may include a sealing assembly 800 disposed about the exterior perimeter 410 of each respective HEPA filter 400 (shown in FIG. 8). The sealing assemblies 800 may include at least one gasket 820 (e.g., composed of a rubber or silicone material) and at least one planar member 810 (e.g., composed of a sheet metal or plastic). The sealing assemblies 800 are configured to prevent a bypass around the HEPA filters 400. For example, the sealing assemblies 800 may be configured in such a way that prevents any of the air that enters the multi-compartment negative air filtration system 100 from passing through the outlet 220 without first passing through a HEPA filter 400. In certain instances, the housing 200 includes a mounting rail 240 extending from the interior surface 230 (e.g., within each compartment 201, 202). The mounting rail 240 may be disposed adjacent to the sealing assemblies 800 (e.g., in an overlapping manner, as shown in FIG. 8).

The design and configuration of the multi-compartment negative air filtration system 100 may make the multi-compartment negative air filtration system 100 easy to install and/or move, which might be advantageous in environments where time is of the essence (e.g., in hospital settings, etc.). Additionally, the multi-compartment negative air filtration system 100 may be designed in such a way that it's footprint (e.g., the amount of space required) is minimal. For example, the multi-compartment negative air filtration system 100 may take up less than 8 square feet of floor space (e.g., the surface area of the lower surface 201 may be less than 4 square feet). This may be possible due to the orientation of the multi-compartment negative air filtration system 100. For example, the multi-compartment negative air filtration system 100 may be configured to be vertically oriented (as shown in FIG. 1) where the outlets 220 are disposed on the upper surface 202 and the inlets 210 are disposed on the lower surface 201. The multi-compartment negative air filtration system 100 may include a plurality of wheels 250 disposed on the lower surface 201 of the housing 200. These wheels 250 may make it possible to move the multi-compartment negative air filtration system 100 between rooms (e.g., from one hospital room to another).

As described above, the design and configuration of the multi-compartment negative air filtration system 100 makes it possible to remove contaminants (e.g., microbes) from air in an effective and reliable manner, with increased flexibility (e.g., when compared to existing negative air machines that only one inlet and only one outlet). As mentioned above, the multi-compartment negative air filtration system 100 described herein, by including multiple compartments, each with their own inlet and outlet, may have increased flexibility for providing optimal treatment. For example, instead of only being able to exhaust the treated in a single direction (i.e., either within the room or outside the room), the multi-compartment negative air filtration system 100 described herein may be able to exhaust the treated air in multiple directions, resulting in increased control of airflow within the room. This benefit is illustrated in FIG. 9, which depicts a room 10 (representing a hospital room). As shown, by operating the second compartment 202 in an air scrubber mode (where the treated air is discharged inside the room 10) and the first compartment 201 in a negative air mode (where the treated air is discharged outside the room 10), the airflow within the room 10 can be optimized. For example, the treated air from the second compartment 202 may be discharged in the nursing station 12, which may cause a positive pressure in the nursing station 12. This may help mitigate airflow from the patient's bed 11 from flowing into the nursing station 12 (which may help prevent further infections of hospital staff, etc.). It will be appreciated that similar configurations may be used in other settings. It is envisioned that either side of the multi-compartment negative air filtration system 100 may be operated in either an air scrubber mode or a negative air mode.

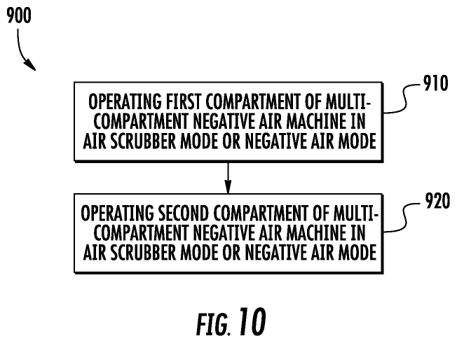

The method 900 for operating a multi-compartment negative air filtration system 100 is shown in FIG. 10. This method 900 may be completed, for example, using the exemplary multi-compartment negative air filtration system 100 shown in FIGS. 1. As described above, the multi-compartment negative air filtration system 100 may include a housing 200 defining a first compartment 201 and a second compartment 202 separated by at least one panel member 203. Each of the first compartment 201 and the second compartment 202 may include a pre-filter 300, a HEPA filter 400 disposed downstream of the pre-filter 300, and a fan assembly 500. As described above, the fan assemblies 500 may be disposed downstream of the HEPA filters 400. The method 900 includes step 910 for operating the first compartment 201 in at least one of an air scrubber mode and a negative air mode, the air scrubber mode being defined by a first exhausted air (exiting the first outlet 220(a)) being discharged within the room 10, the negative air mode being defined by the first exhausted air (exiting the first outlet 220(a)) being discharged outside the room 10. The method 900 includes step 920 for operating the second compartment 202 in at least one of an air scrubber mode and a negative air mode, the air scrubber mode being defined by a second exhausted air (exiting the second outlet 220(b)) being discharged within the room 10, the negative air mode being defined by the second exhausted air (exiting the second outlet 220(b)) being discharged outside the room 10. In certain instances both the first compartment 201 and the second compartment 202 are operated identically (e.g., in the same mode). However, as described above and shown in FIG. 9, in certain instances one of the first compartment 201 and the second compartment 202 are operated in the air scrubber mode and one of the first compartment 201 and the second compartment 202 are operating in negative air mode.

The use of the terms “a” and “and” and “the” and similar referents, in the context of describing the invention, are to be construed to cover both the singular and the plural, unless otherwise indicated herein or cleared contradicted by context. The use of any and all example, or exemplary language (e.g., “such as”, “e.g.”, “for example”, etc.) provided herein is intended merely to better illuminate the invention and does not pose a limitation on the scope of the invention unless otherwise claimed. No language in the specification should be construed as indicating any non-claimed elements as essential to the practice of the invention.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A multi-compartment negative air filtration system comprising:
a housing comprising a first compartment and a second compartment, the first compartment and the second compartment separated by at least one panel member, each of the first compartment and the second compartment comprising:
an inlet and an outlet;
a pre-filter disposed downstream of the inlet;
a HEPA filter disposed downstream of the pre-filter; and
a fan assembly disposed downstream of the HEPA filter, the fan assembly in airflow communication with the pre-filter and the HEPA filter, the fan assembly generating a negative pressure across the pre-filter and the HEPA filter.

2. The multi-compartment negative air filtration system of claim 1, wherein the fan assembly of the first compartment and the fan assembly of the second compartment share a constant torque motor comprising an operating torque.

3. The multi-compartment negative air filtration system of claim 2, wherein the constant torque motor is operably connected to a selection device, the selection device configured to adjust the operating torque.

4. The multi-compartment negative air filtration system of claim 3, wherein operating torque correlates to an approximately constant RPM, wherein the approximately constant RPM is between 800 and 1500 RPM.

5. The multi-compartment negative air filtration system of claim 1, wherein the fan assembly of the first compartment and the fan assembly of the second compartment each independently comprise a forward curved wheel blower.

6. The multi-compartment negative air filtration system of claim 1, wherein the housing further comprises an interior surface, wherein an insulation is disposed on at least a portion of the interior surface.

7. The multi-compartment negative air filtration system of claim 6, wherein the insulation comprises an exterior foil surface and a fiberglass body.

8. The multi-compartment negative air filtration system of claim 1, wherein each respective outlet comprises a supply duct transition, each supply duct transition comprising an outlet flange and an outlet plate, wherein the outlet plate includes a plurality of apertures disposed therein.

9. The multi-compartment negative air filtration system of claim 1, further comprising at least one pressure switch, the pressure switch operably connected to an indicator, the indicator disposed on the housing.

10. The multi-compartment negative air filtration system of claim 9, wherein the pressure switch comprises a tube, the tube comprising a first end and a second end, the first end disposed outside the housing and the second end disposed between the fan assembly and the HEPA filter.

11. The multi-compartment negative air filtration system of claim 9, wherein the indicator is configured to signal when at least one of the pre-filter and the HEPA filter are in need of replacement.

12. The multi-compartment negative air filtration system of claim 1, wherein the HEPA filter comprises an exterior perimeter, a sealing assembly disposed about the exterior perimeter, the sealing assembly configured prevent a bypass around the HEPA filter.

13. The multi-compartment negative air filtration system of claim 12, wherein the sealing assembly comprises at least one gasket and at least one planar member.

14. The multi-compartment negative air filtration system of claim 12, further comprising a mounting rail disposed within the housing, the mounting rail disposed adjacent the sealing assembly.

15. The multi-compartment negative air filtration system of claim 1, wherein the inlet is disposed on a lower surface of the housing and the outlet is disposed on an upper surface of the housing, the inlet and the outlet being vertically oriented.

16. The multi-compartment negative air filtration system of claim 15, further comprising a plurality of wheels disposed on the lower surface of the housing.

17. The multi-compartment negative air filtration system of claim 15, wherein the lower surface comprises a surface area less 8 sq. ft.

18. A method for operating a multi-compartment negative air filtration system within a room, the multi-compartment negative air filtration system comprising a housing comprising a first compartment and a second compartment separated by at least one panel member, each of the first compartment and the second compartment comprising a pre-filter, a HEPA filter disposed downstream of the pre-filter, and a fan assembly disposed downstream of the HEPA filter, the method comprising:
operating the first compartment in at least one of an air scrubber mode and a negative air mode, the air scrubber mode being defined by a first exhausted air being discharged within the room, the negative air mode being defined by the first exhausted air being discharged outside the room; and
operating the second compartment in at least one of an air scrubber mode and a negative air mode, the air scrubber mode being defined by a second exhausted air being discharged within the room, the negative air mode being defined by the second exhausted air being discharged outside the room.

19. The method of claim 18, wherein both the first compartment and the second compartment are operated identically.

20. The method of claim 18, wherein one of the first compartment and the second compartment are operated in the air scrubber mode and one of the first compartment and the second compartment are operating in negative air mode.
